(19) United States
(12) Patent Application Publication
(10) Pub. No.: US 2008/0109717 A1
(43) Pub. Date: May 8, 2008

(54) REVIEWING EDITING OPERATIONS

(75) Inventor: Klaus Krauter, Caringbah (AU)

Correspondence Address: FITZPATRICK CELLA HARPER & SCINTO, 30 ROCKEFELLER PLAZA, NEW YORK, NY, 10112, US

(73) Assignee: Canon Information Systems Research Australia Pty. Ltd., North Ryde (AU)

(21) Appl. No.: 11/933,585

(22) Filed: Nov. 1, 2007

(30) Foreign Application Priority Data
Nov. 3, 2006 (AU) 2006235850

(51) Int. Cl. G06F 17/24

(52) U.S. Cl. 715/255

(57) ABSTRACT

A method of reviewing editing operations applied in a document. The method includes using a processing system to determining a first sequence of first editing operations applied to first objects in the document. For at least one second object, the at least one second object being selected from the first objects, the processing system determines at least one second editing operation from the first sequence of first editing operations and then displays a second representation indicative of the at least one second editing operation.

### FIELD OF THE INVENTION

The present invention relates to a method and apparatus for reviewing editing operations, and in particular to a method and apparatus for allowing review of editing operations applied to selected objects within a document.

### DESCRIPTION OF THE BACKGROUND ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

In document editing applications, such drawing or word processing packages, it is known to provide undo and redo operations to allow editing operations to be reversed and re-applied. Typical current practice is to provide an editing history as a linear chronological time sequence for all operations performed on a document. This allows a user to move backwards in the editing sequence to reverse the editing operations applied to objects in the document. If the user has incorrectly reversed editing operations, the user can select a redo operation, allowing the editing operations to be re-applied to the objects by moving forward from the current point in the editing sequence. Typically the undo/redo history is only maintained during an editing session, so that this information is lost when an editing session is finished and the document saved.

JP07295978 describes providing a visual history consisting of a list thumbnails for the entire state of the page. This allows the user to view the effects of the undo prior to performing the undo operation.

U.S. Pat. No. 6,750,890 describes a history of thumbnails for image processing operations applied to a pixel image underneath an editing window. In this example, the user can select one of the thumbnails and the image is restored to that state.

US2005/0102630 describes a method for combining or manipulating elements from different windows in a separate “MetaWindow”. The elements that are combined are traced back to their original source. Undo operations for the contents in the “MetaWindow” are based on the operations provided by the applications for the source.

Whilst these documents describe, for example, the use of a visual history, this still only allows undo operations to be applied to all editing operations applied to the document. This can be a major drawback when editing graphical documents when different parts of the artistic composition can appear optimal at different points in a long editing session.

For example, the user may apply a sequence of editing operations to obtain an optimal appearance for a first part of the document, and in doing so apply unwanted editing operations to a second part of the document. As a result, a desired appearance of the second part may be lost. In this instance, the user may undo editing operations to retrieve the desired appearance for the second part, and in doing so, the user may lose the effect of desirable editing operations applied the first part of the document. Thus, in this instance, the undo/redo history means the user must undo the editing operations applied to recover the previous state of the second part, and then reapply the reversed editing operations to the first part of the document only. However, as the sequence of editing operations may be complex, this is not always feasible, and can in any event be extremely time consuming and frustrating.

### SUMMARY OF THE PRESENT INVENTION

It is an object of the present invention to substantially overcome, or at least ameliorate, one or more disadvantages of existing arrangements.

In a first broad form the present invention provides a method of reviewing editing operations applied in a document, the method including, in a processing system:
a) determining a first sequence of first editing operations applied to first objects in the document;
b) for at least one second object, the at least one second object being selected from the first objects, determining at least one second editing operation from the first sequence of first editing operations; and,
c) displaying a second representation indicative of the at least one second editing operation.

In a second broad form the present invention provides apparatus for reviewing editing operations applied in a document, the apparatus including a processing system for:
a) determining a first sequence of first editing operations applied to first objects in the document;
b) for at least one second object, the at least one second object being selected from the first objects, determining at least one second editing operation from the first sequence of first editing operations; and,
c) displaying a second representation indicative of the at least one second editing operation.

In a third broad form the present invention provides a computer program product for reviewing editing operations applied in a document, the computer program product including computer executable code which when executed on a suitable programmed processing system, causes the processing system to:
a) determine a first sequence of first editing operations applied to first objects in the document;
b) for at least one second object, the at least one second object being selected from the first objects, determine at least one second editing operation from the first sequence of first editing operations; and,
c) display a second representation indicative of the at least one second editing operation.

### BRIEF DESCRIPTION OF THE DRAWINGS

An example of the present invention will now be described with reference to the accompanying drawings, in which:—

FIG. 1 is a flow chart of an example of a process for reviewing editing operations;

FIG. 2 is a schematic diagram of an example of a general purpose computer system;

FIGS. 3A and 3B are a flow chart of an example of a process for reviewing editing operations using the computer system of FIG. 2;

FIG. 4 is a schematic diagram of an example of a user interface displaying a document for editing;

FIGS. 5A to 5F are schematic diagrams of an example of a sequence of editing operations applied to the document of FIG. 4;

FIG. 6 is a schematic diagram of an example of the user interface of FIG. 4 showing a history of editing operations for a selected object;

FIGS. 7A and 7B are schematic diagrams of an example of a history of editing operations for a second selected object;

FIG. 8 is a schematic diagram of an example of the document as modified by a selected editing operation for a selected object;

FIG. 9 is a flow chart of a first example of a process for determining editing operations applied to a selected object;

FIG. 10 is a flow chart of a second example of a process for determining editing operations applied to a selected object;

FIGS. 11A and 11B are schematic diagrams of an example of an editing operation applied to a group of objects; and,

FIGS. 12A to 12E are schematic diagrams of an example of a history of editing operations for two second objects.

### DETAILED DESCRIPTION INCLUDING BEST MODE

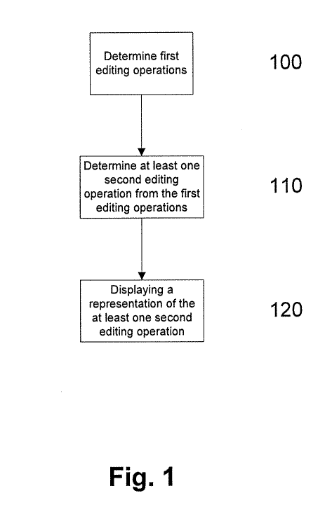

An example of a process for reviewing editing operations applied in a document will now be described with reference to FIG. 1.

In this example, at step 100, the process involves determining a first sequence of first editing operations applied to first objects in a document. The first objects are any objects within the document to which first editing operations have been applied.

The determination of the first sequence may be achieved in any one of a number of ways and may involve for example reviewing previously applied editing operations that are stored in a global edit history. Alternatively, this may involve monitoring and/or performing editing operations on objects within the document, although any suitable mechanism may also be used.

At step 110 at least one second editing operation is determined. The at least one second editing operation is an editing operation that is applied to at least one second object, the at least one second object being a selected one of the first objects. Thus, second editing operations typically form a subset of the first editing operations, with second editing operations being applied to second objects, which form a subset of the first objects.

Determination of the second editing operations may be achieved in any one of a number of manners. For example a user can select or choose second objects from the first objects. The second editing operations can then be extracted from the global edit history based on an identity of the second objects. Alternatively, a sequence of editing operations may be maintained for each object, allowing the relevant sequence to be retrieved based on the identity of the second objects.

At step 120, a representation of the at least one second editing operation is displayed. This may be achieved in any one of a number of manners again depending on the preferred implementation. Thus, for example, the representation may simply be a text based list of the second editing operations. Alternatively the representation may include an indication of changes in the visual appearance of the second object caused by the second editing operations. Any other suitable representation may also be utilised.

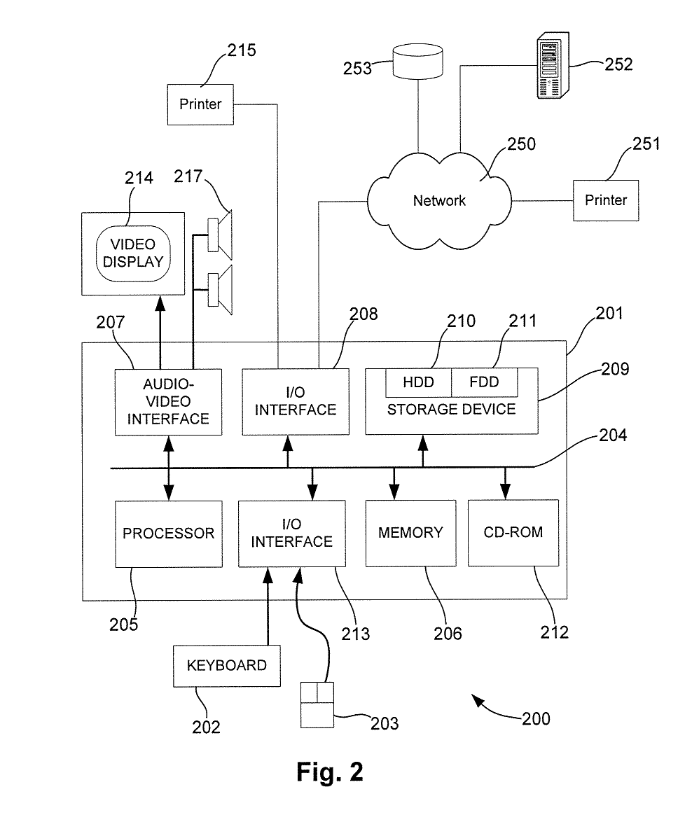

It will be appreciated that the above described procedure can be performed at least in part utilising a computer system. An example of a general-purpose computer system is shown in FIG. 2.

In this example, the computer system 200 is formed by a computer module 201, input devices such as a keyboard 202 and mouse 203, and output devices including a printer 215, a display device 214 and loudspeakers 217.

The computer module 201 typically includes at least one processor unit 205, and a memory unit 206, for example formed from semiconductor random access memory (RAM) and read only memory (ROM).

The module 201 includes an number of input/output (I/O) interfaces including an audio-video interface 207 that couples to the video display 214 and loudspeakers 217, and an I/O interface 213 for the keyboard 202 and mouse 203 and optionally a joystick (not illustrated). This allows the computer system 200 to determine and interpret user input commands supplied by a user.

An I/O interface 208, such as a network interface card (NIC) is also typically used for connecting the computer module 201 to a computer network 250, which can optionally provide onward connectivity to a network printer 251, a network server 252 and a database 253. The I/O interface 208 can also provide connectivity to the printer 215.

A storage device 209 is provided and typically includes a hard disk drive 210 and a floppy disk drive 211. A magnetic tape drive (not illustrated) may also be used. A CD-ROM drive 212 is typically provided as a non-volatile source of data.

The components 205 to 213 of the computer module 201, typically communicate via an interconnected bus 204 and in a manner that results in a conventional mode of operation of the computer system 200 known to those in the relevant art. Examples of computers on which the described arrangements can be practised include IBM-computer's and compatibles, Sun Sparcstations or the like.

The processes of performing and reviewing editing of documents is typically implemented using software, such as one or more application programs executing within the computer system 200. Typically, the application activates a GUI on the video display 214 of the computer system 200, which displays a visual representation of the document being edited, and optionally a visual representation of the appearance of specific objects.

In particular, the methods and processes are affected by instructions in the software that are carried out by the computer. The instructions may be formed as one or more code modules, each for performing one or more particular tasks. Typically the execution of the instructions may require a number of different application programs to interact, and may also require the presence of a suitable drivers or the like.

The software may be stored in a computer readable medium, and loaded into the computer, from the computer readable medium, to allow execution. A computer readable medium having such software or computer program recorded on it is a computer program product. The use of the computer program product in the computer preferably affects an advantageous apparatus for distributed printing, scanning or copying.

The term “computer readable medium” as used herein refers to any storage or transmission medium that participates in providing instructions and/or data to the computer system 200 for CD-ROM, a hard disk drive, a ROM or integrated circuit, a magneto-optical disk, or a computer readable card such as a PCMCIA card and the like, whether or not such devices are internal or external of the computer module 201. Examples of transmission media include radio or infra-red transmission channels as well as a network connection to another computer or networked device, and the Internet or Intranets including e-mail transmissions and information recorded on Websites and the like.

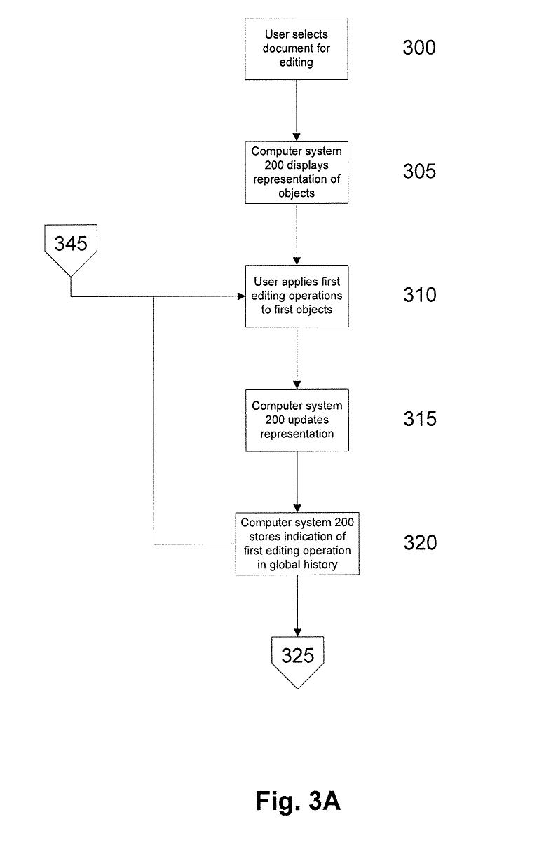

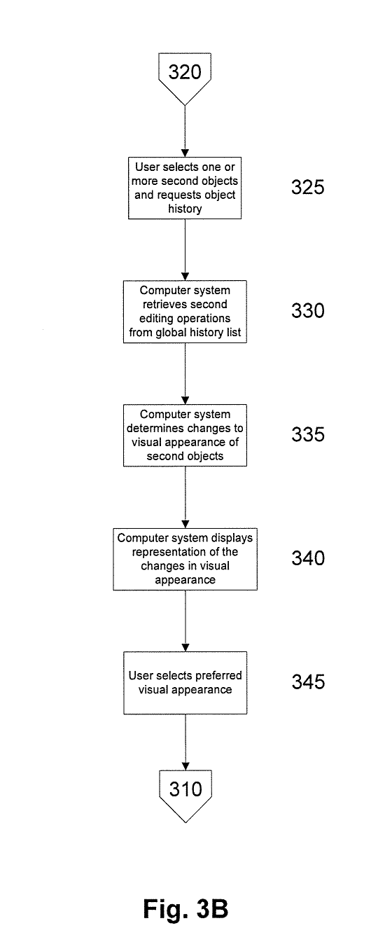

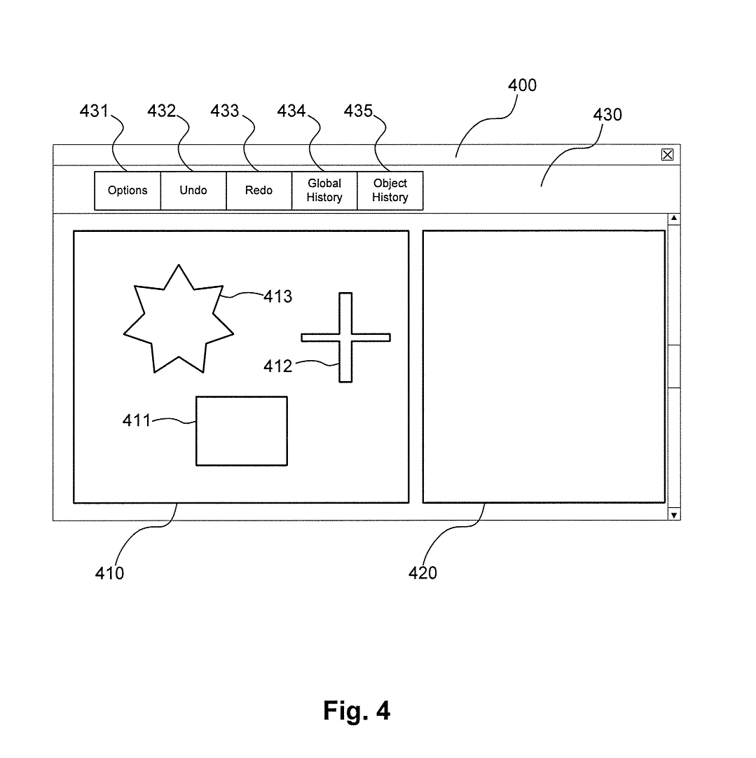

An example of the process of reviewing editing operations utilising the computer system 200 will now be described with reference to the flow chart of FIGS. 3A and 3B and the example interface shown in FIG. 4.

At step 300 a user loads a document for editing. This will typically involve having the user select and launch a suitable document editing application on the computer system 200, before selecting a document of interest from available documents, and then opening this using the editing application.

At step 305, the computer system 200 operates to display a representation of the document. This typically involves having the computer system 200 determine a visual appearance of any objects contained within the document, before displaying this as part of a suitable a graphical user interface (GUI). An example of this is shown in more detail in FIG. 4.

In this example, the GUI 400 includes a document window 410, a history window 420, and a tool bar 430, including a number of command buttons shown generally at 431, . . . 435.

The document window 410 displays a first representation that is indicative of the visual appearance of objects within the document. In this example the document includes three objects in the form of a rectangle 411, a cross 412 and a star 413. It will be appreciated that this is for the purpose of example only and any objects may be provided including, but not limited to text, images, graphics or the like.

The history window 420 can be used to display a second representation that is indicative of either a sequence of first editing operations (known as the global edit history) or a sequence of second editing operations (known as the local edit history), depending on selection of either a global history command button 434 or a local or object history command button 435 respectively.

In this example the command buttons also include an options button 431, an undo button 432, and a redo button 433, which are used to allow options, as well as undo and redo operations to be controlled. However, it will be appreciated that these control buttons are for the purpose of example only and that typically the tool bar 430 would include a number of additional or alternative command buttons (not shown), for example to allow editing operations to be performed. Such commands buttons are generally known in the art and will not therefore be described in further detail.

Initially, when the computer system 200 displays the first representation at step 305, this is achieved by displaying objects within the document in the document window 410. Thus, for example, the appearance of the GUI 400 is as shown in FIG. 4, with the objects 411, 412, 413 displayed in the document window 410 and with nothing displayed in the history window 420.

At step 310 the user applies first editing operations to first objects, which are generally determined to be any objects within the document to which the user applies first editing operations.

The first editing operations may be any form of editing operation including for example, moving an object, resizing an object, reshaping an object, changing an object's colours or fill, adding an object, removing an object, or the like. This may also include editing text or the like.

It will be appreciated that these editing operations may be affected in any manner, but typically involve having the computer system 200 interpret input commands supplied by a user, for example, via the keyboard 202 and mouse 203. Thus, the editing process may involve having a user move an object, for example by selecting and then dragging the object using a mouse pointer. Such editing operations are generally known in the art and will not therefore be described in any further detail.

After applying a first editing operation, the computer system 200 calculates a change in the visual appearance of the document, and updates the first representation displayed in the document window 410 at step 315.

The computer system 200 also stores an indication of the first editing operation in a global edit history, which is typically maintained in a suitable store, such as the memory 206, at step 320. The global edit history typically includes an indication of the first editing operation performed and an indication of an identity of the first object to which the editing operation is applied. This could be achieved in one of two ways, such as by storing an indication of each object, together with any editing operations applied thereto. Typically however, this involves storing an indication of each of the editing operations in order, together with an indication of the objects to which each editing operation was applied, as will be described in more detail below.

Following this, the process can either return to step 310 to allow further first editing operations to be performed, or can continue to step 325, to allow editing operations to be reviewed, as will be described in more detail below.

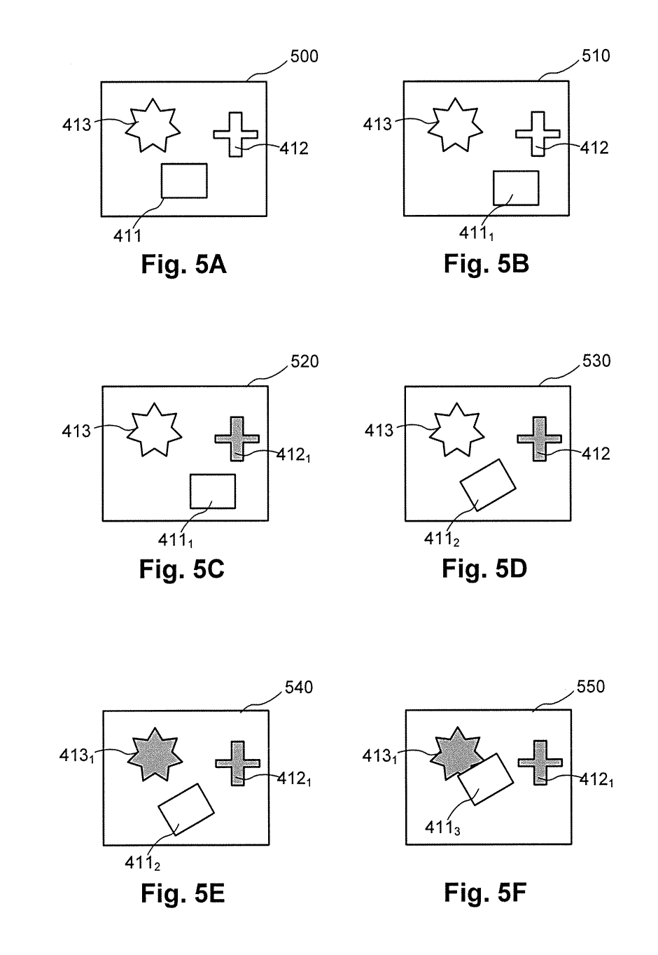

An example sequence of first editing operations as applied to the document displayed as part of the GUI 400 will be described with reference to FIGS. 5A to 5F.

For the purpose of this explanation, each of the objects including the rectangle 411, the cross 412 and the star 413 will be designated utilising the same reference numerals throughout, but with the reference numeral being modified to include a subscript indicative of the number of editing operation applied to that particular object. Thus, if an editing operation is applied to the rectangle 411, the rectangle is designated with the reference number 411₁.

In this example, the initial visual appearance of the document is shown in first representation 500 in FIG. 5A. At step 310 a user applies a first editing operation that involves moving the rectangle 411. At step 315 the computer system 200 calculates the visual appearance of the document after the editing operation is applied to the rectangle 411, and updates the GUI 400 accordingly. Thus, in this instance, the visual appearance of the document is as shown in first representation 510 in FIG. 5B, with the moved rectangle being designated by the reference numeral 411₁ indicating that a single editing operation has been applied to the rectangle 411.

An indication of the movement is then stored in a global edit history, at step 320. The stored indication generally includes an indication of the first editing operation and an identity of each first object to which the operation is applied, as shown in more detail below. Once the indication is stored the process returns to step 310 allowing further operations to be performed, as shown in the first representations in FIGS. 5C to 5F.

The first editing operations performed in this example therefore include:
applying a movement to the rectangle 411 as shown at 411₁ in first representation 510;
applying a colour to the cross 412 to form a coloured cross 412₁ in first representation 520;
applying a rotation and movement to the rectangle 411₁ as shown at 411₂ in first representation 530;
applying a colour change to the star 413 to form a coloured star 413₁ in first representation 540; and,
applying a movement to the rectangle 411₂ as shown at 411₃ in first representation 550.

It will be appreciated that after completion of this the GUI 400 shown in FIG. 4 would include the first representation 550 in the document window 410.

An example of the global edit history obtained for this sequence of first editing operation is shown in table 1 below. In this example, the global edit history includes an indication of the first editing operations performed in sequence, together with an indication of the objects to which the editing operation is applied, which is typically in the form of an object identity.

TABLE 1

| Number | Operation Type | Objects |
|---|---|---|
| 1 | Movement | Rectangle 411 |
| 2 | Colour Change | Cross 412 |
| 3 | Rotation and Movement | Rectangle 411₁ |
| 4 | Colour Change | Star 413 |
| 5 | Movement | Rectangle 411₂ |

For the purpose of this example, the editing operations are identified by a number to show the sequence and allow easy identification.

The nature of editing operation is specified in general terms in the operation type field, and it will be appreciated that in practice additional detail will be stored. Thus, in this example, if the first editing operation involves movement, the global edit history merely specifies movement, whereas in practice it would typical to specify the position of the relevant object before and after the editing operation.

Additionally, editing operations may be applied to a number of objects simultaneously, in which case multiple objects may be listed against a given editing operation, where appropriate. Alternatively, a group operation may be used to define an object formed from a group of objects, with the group being listed against subsequent editing operation as if it were a single object.

Once the editing operations have been performed, and an indication of the editing operations stored, for example, in the global edit history, then at step 325 the user can select one or more second objects from the first objects, and request a local edit history indicative of the editing operations applied to the second object. It will be appreciated from this that the term “second object” refers to a selected one of the first objects.

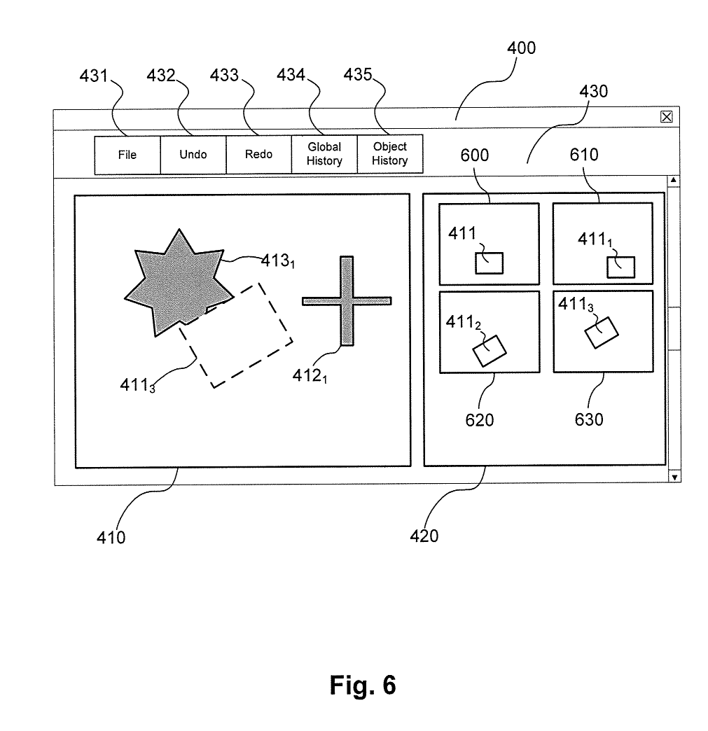

An example of this is shown in detail in FIG. 6. In this instance, the user selects the rectangle 411 by designating the rectangle 411₃, for example by clicking on the representation of the rectangle 411₃ using a mouse pointer or the like. This causes the computer system 200 to update the first representation shown in the document window 410, to highlight the selection, as shown for example by the use of dotted lines in FIG. 6.

Following selection of the rectangle 411 the user selects the local history command button 435. At step 330 this causes the computer system to retrieve a list of second editing operations from the global edit history. The second editing operations are editing operations that have been applied to the selected second object, in this example the rectangle 411₃, and this can therefore be achieved by having the computer system 200 determine the identity of the second object and then use the identity to determine the first editing operations that were applied to the second object.

Thus, the editing operations retrieved from the global edit history, which form a second sequence of second editing operation, would be as shown in Table 2, for this example.

TABLE 2

| Number | Operation Type | Objects |
|---|---|---|
| 1 | Movement | Rectangle 411 |
| 3 | Rotation and Movement | Rectangle 411₁ |
| 5 | Movement | Rectangle 411₂ |

At step 335 the computer system 200 determines changes in the visual appearance of the second object and uses this to display the second representation indicative of the second editing operations in the history window 420 at step 340.

In this example, this is achieved by determining the visual appearance of the second object, in this case the rectangle 411, before and after each second editing operation is applied thereto, with a separate indication of each visual appearance being displayed in the history window 420, as shown at 600, 610, 620, and 630. Thus, for each second editing operation, the computer system 200 determines a first visual appearance of the second object before the second editing operation is applied, and a second visual appearance of the second object after the second editing operation is applied. In one example, the indication of each visual appearance is in the form of a thumbnail, although any suitable indication may be used.

In any event, the rectangle 411 prior to any editing operations being applied thereto is shown in thumbnail 600. The thumbnails 610, 620, 630 then show the appearance of the rectangle 411 after each of the second editing operations is applied, as shown at 411₁, 411₂, 411₃. It will be appreciated that the number of representations shown within the history window 420 will depend on the number of editing operations performed.

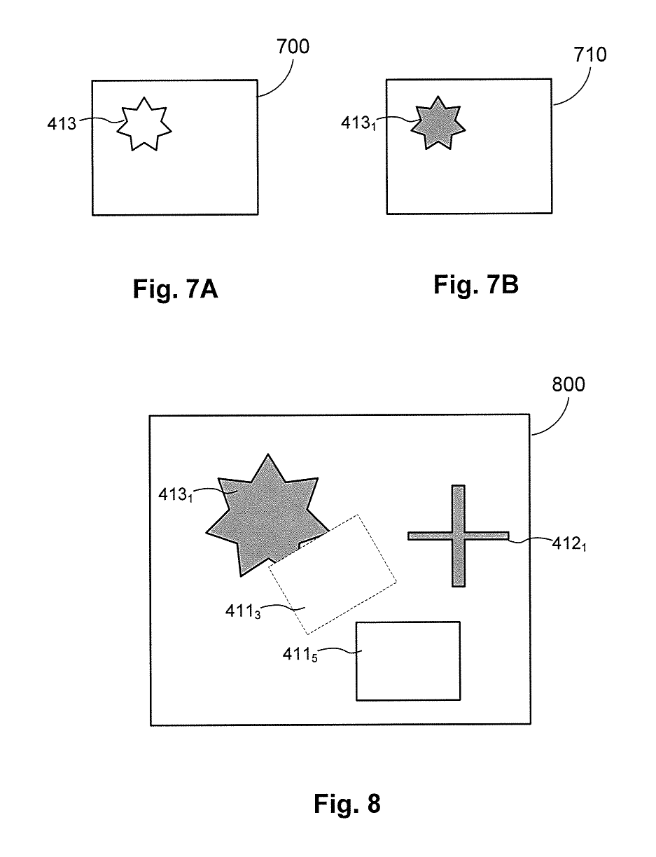

Thus, for example, if the user selects the star 413 as the second object, then the computer system would determine only a single second editing operation, which in turn leads to two thumbnails being displayed, as shown at 700 and 710 in FIGS. 7A and 7B. Thus, in this example, the thumbnails 700, 710 would be displayed in the history window 420 to show the appearance of the star 413 prior to the colour change editing operation and after the colour change editing operation as shown at 413₁.

In any event, after having displayed the second representation at step 340, the user can then assess whether any of the second editing operations should be applied to the document. Thus, for example, the user can select which of the visual appearances they prefer for the selected second object at step 345. This could be achieved for example by having the user designate one of the thumbnails 600, 610, 620, 630, shown in the history window 420, using the mouse 203.

If the user selects one of the thumbnails 600, 610, 620, 630, this causes the visual appearance of the corresponding second object to return to that in the selected thumbnails 600, 610, 620, 630. To achieve this, the computer system effectively extracts any second editing operations applied to the second object since the desired visual appearance and then reapplies these to the second object as an undo operation. Accordingly, the process returns to step 310, allowing the computer system 200 to use an undo edit operation to reverse the selected second editing operations. The computer system 200 can then update the representation shown in the document window 410, and subsequently update the global edit history at step 320.

Thus, if the user were to select the representation 610 shown in the history window 420 then this will cause the computer system to determine that the rectangle 411₃ should be edited to return it to the visual appearance shown by the rectangle 411₁. To achieve this, the computer system 200 will perform new edit operations that act to undo the movement edit 5 and the rotation and movement edit 3.

It will be appreciated that the global edit history will also be updated accordingly by storing an indication of the selected second editing operation as a first editing operation, and an example of this is shown below in table 3.

TABLE 3

| Number | Operation Type | Objects |
|---|---|---|
| 1 | Movement | Rectangle 411 |
| 2 | Colour Change | Cross 412 |
| 3 | Rotation and Movement | Rectangle 411₁ |
| 4 | Colour Change | Star 413 |
| 5 | Movement | Rectangle 411₂ |
| 6 | Undo Edit Operation 5 | Rectangle 411₃ |
| 7 | Undo Edit Operation 3 | Rectangle 411₄ |

As an alternative however, a single editing operation could replace the multiple undo operations shown at 6 and 7. In this example, the single editing operation performs a single combined movement and rotation to undo both the movement operation from edit operation 5 and the rotation and movement operation from the edit operation 3. In other words, this corresponds to a single editing operation that moves the rectangle 411₃ from the position shown in FIG. 5F to the position shown in FIG. 8 below. It will be appreciated that in this example, the global edit history would require only a single entry instead of the two entries corresponding to the edit operations 6 and 7.

An example of the finalised document is as shown by representation 800 in FIG. 8. In this instance the appearance of the rectangle 411₃ prior to selecting the representation 610 is shown in dotted lines for clarity purposes only, with the newly edited rectangle being shown at 411₅ indicating that a total of five editing operations have been applied to rectangle 411.

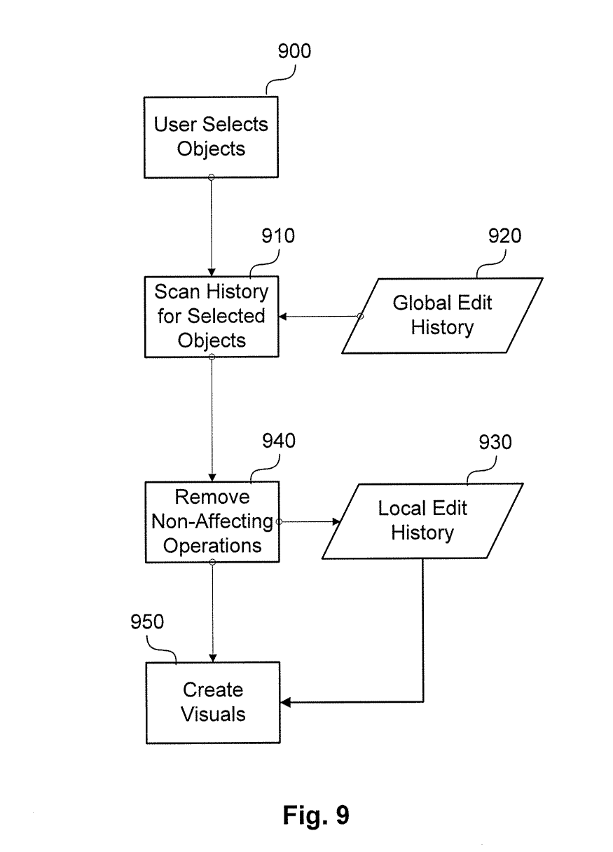

Once this process is completed, or at any time during the process, an indication of the visual appearance of the document may be stored to allow this to be subsequently retrieved. An example method for allowing the computer system 200 to retrieve the second editing operations from the global edit history will now be described in more detail with respect to FIG. 9.

In this example, at step 900, the user selects one or more of the objects displayed in the document window 410 to thereby designate the selected objects as second objects. At step 910, the computer system 200 then scans the global edit history shown at 920. This allows the computer system 200 to determine a list of all operations affecting the selected second object(s) to form a local edit history of second editing operations at step 930.

The computer system 200 then removes any non-affecting operations from the local edit history at step 940, before creating the second representation indicative of the second editing operations remaining in the local edit history at step 950.

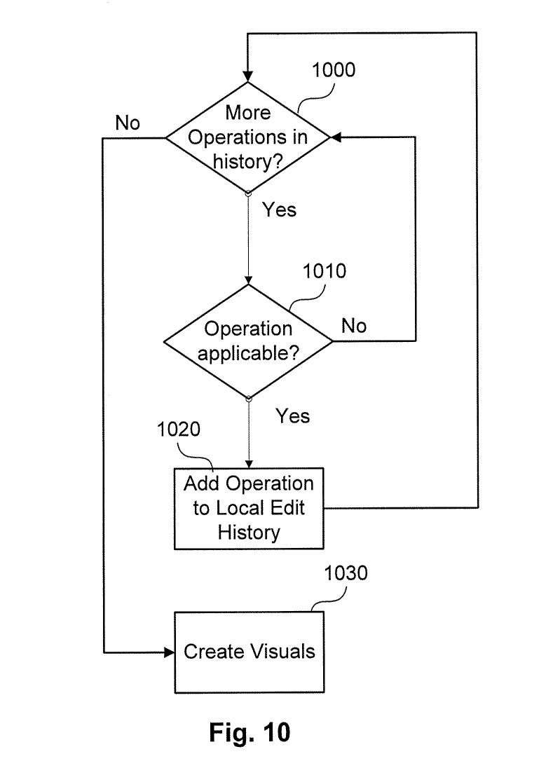

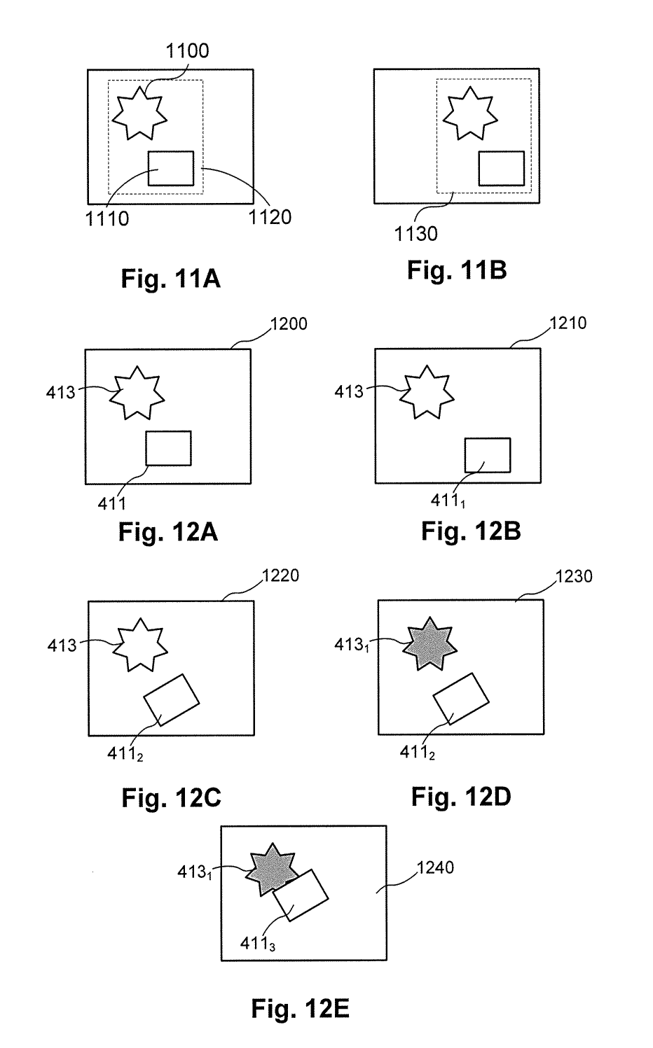

The method for applying a filter to the global edit history to remove non-affecting operations at step 940 will now described in more detail with respect to FIG. 10.

In this example, at step 1000 the computer system 200 scans the global edit history to determine if there are further first operations in the global edit history. If so, the process moves on step 1010 to determine if the next first operation in the global edit history results in modification of the visual appearance of any second object(s). If there is no impact on the visual appearance, the process returns to step 1000. Otherwise, the first operation is added to the local edit history as a second operation at step 1020, before the process again returns to step 1000. Once no further first operations are present in the global edit history, then the process moves onto step 1030, allowing the representations to be generated as previously described.

It will be appreciated that the above described examples have focussed on situations in which a single editing operation is associated with a single object. However this need not be the case, and as will be appreciated by those skilled in the art, editing operations can be applied to a number of objects simultaneously.

An example of this is shown in FIGS. 1A and 1B, in which a document is provided containing two objects in the form of star 1100 and rectangle 1110. In this example, the user can select both of the objects using an appropriate command, such as by dragging the mouse 203 to define a region containing the objects of interest, as shown generally at 1120. In this example, the objects can then be moved collectively as a group, such that the same first operation is applied to both of the objects 1100, 1110, as shown generally at 1130.

It will be appreciated that in this instance, the global edit history will typically identify a group operation, follow by a movement operation applied to the group as a whole, so that the group effectively forms an object itself. An example of the global edit history is shown in table 4.

TABLE 4

| Number | Operation Type | Objects |
|---|---|---|
| 1 | Group | Star 1100 |
| | | Rectangle 1110 |
| 2 | Movement | Group 1120 |

It will be appreciated that determination of second editing operations may be handled in one of two different ways depending on the implementation. For example, the movement of a group can be considered as a single editing operation applied to the group as a whole, or an identical movement operation applied to each of the objects in the group.

In the former case, if the user selects the rectangle 1110 as a second object, and requests an edit history the group operations (group and movement) can be discarded since they are editing operations applied to the group 1120 not to the selected rectangle 1110. Alternatively, selection of the rectangle 1110 can result in the group movement operation being decomposed into a movement operation for each of the objects 1100, 1110 in the group 1120, such that the edit history for the rectangle 1110 would include a movement operation, as shown in Table 5.

TABLE 5

| Number | Operation Type | Objects |
|---|---|---|
| 1 | Movement | Rectangle 1110 |

It will also be appreciated that multiple objects can be selected in a similar manner when choosing the second objects.

Thus, for example, if the star 413 and rectangle 411 are selected in the example described above with respect to FIG. 4, then the selection history list would be as shown in Table 6.

TABLE 6

| Number | Operation Type | Objects |
|---|---|---|
| 1 | Movement | Rectangle 411 |
| 3 | Rotation and Movement | Rectangle 411₁ |
| 4 | Colour Change | Star 413 |
| 5 | Movement | Rectangle 411₂ |

In this example, when generating the representations, it is possible to display representations separately for each of the objects. Thus, in this example, the GUI 400 would display both the representations 600, 610, 620, 630, and the representations 700, 710.

However as an alternative, the representations can be combined, so that each representation shows the appearance of the star 413 and the rectangle 411 after a respective editing operation. This is generally shown in the representations 1200, 1210, 1220, 1230, 1240 in FIGS. 12A to 12E.

Accordingly the above described method allows for the reconstruction of editing operations relevant to at least one second object determined from a user indicated selection of one or more objects in a document. In one example, this is achieved by having the user select at least one object using a pointing device such as a mouse cursor, with the second objects then being highlighted or indicated in some manner. The user can also either select multiple objects one at a time or select a region containing multiple objects. This allows users to select non-contiguous regions of the document and review the sequence of operations across multiple objects in a easily understandable visual format.

Once the second objects are selected, the user can request a review of the editing operations applied to the second objects. In one example, this is achieved by having a computer system 200 examine a global editing sequence and extract from this relevant second editing operations. This allows a second sequence of the second editing operations to be reconstructed to provide a relevant undo/redo sequence for the second objects.

The editing operations can be represented as visual indicators such as thumbnails, which represent the visual appearance of the second objects when the editing operations are applied.

This enables the user to undo/redo selected editing operations allowing these selected second operations to be applied to the corresponding second objects.

A further advantage of this process is that the editing application implemented by the computer system need only maintain a standard global edit history in the form of a last-in first-out queue of editing operations applied to the document. Each editing operations contains a list of objects in the document that were affected. There is no need to have separate undo/redo queue for each object. This allows the process to be implemented without requiring additional application complexity. This, in turn allows the process to be implemented as a plug-in to existing applications.

In one example, any second editing operation selected from the local edit history and applied to second objects can be appended to the global edit history so that the global edit history continues to function as expected by the user.

As a result, the process can provide several advantages over previous systems. For example, it allows a user to restrict the edit history to objects of interest only. The user also does not have to undo wanted edits if they are outside the region of interest. The user can undo the effect of multiple object editing operations for only selected objects without having to go through a tedious and error prone undo, reselect, and apply operation. It also does not require a special user interface component such as a combination editing window. The user does not have to recombine multiple edits into a single object and then apply the object to the document.

In the above described examples, specific reference is made to applications software. However, it will be appreciated that this encompasses multiple software applications, elements, or other modules, such as drivers, or the like.

The term editing operation is intended to encompass any document processing operation that at least in part alters the visual appearance of one of more objects within the document. The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1) A method of reviewing editing operations applied in a document, the method including, in a processing system:
a) determining a first sequence of first editing operations applied to first objects in the document;
b) for at least one second object, the at least one second object being selected from the first objects, determining at least one second editing operation from the first sequence of first editing operations; and,
c) displaying a second representation indicative of the at least one second editing operation.

2) A method according to claim 1, wherein the method includes, in the processing system:
a) for the at least one second editing operation, determining a change in visual appearance of the at least one second object; and,
b) generating the second representation using the determined change in visual appearance.

3) A method according to claim 2, wherein the method includes, in the processing system:
a) determining a first visual appearance of the at least one second object before the at least one second editing operation is applied to the at least one second object;
b) determining at least one second visual appearance of the at least one second object after the at least one second editing operation is applied to the at least one second object; and,
c) generating the second representation using the first visual appearance and the at least one second visual appearance.

4) A method according to claim 1, wherein the method includes, in the processing system, storing an indication of the first sequence of first editing operations by storing, for each first operation:
a) an indication of the first operation; and,
b) an identity of each first object to which the first operation is applied.

5) A method according to claim 4, wherein the method includes, in the processing system:
a) determining an identity for the at least one second object; and,
b) determining the at least one second editing operation by selecting at least one first editing operation applied to the at least one second object using the determined identity.

6) A method according to claim 4, wherein the method includes, in the processing system, determining the at least one second editing operations by applying a filter to the stored indication of first operations.

7) A method according to claim 1, wherein the method includes, in the processing system, and for a plurality of second editing operations, determining a second sequence of second editing operations.

8) A method according to claim 1, wherein the method includes, in the processing system:
a) determining the selection of at least one second editing operation; and,
b) applying the selected at least one second operation to the at least one second object.

9) A method according to claim 9, wherein the method includes, in the processing system, storing an indication of the selected at least one second operation as a first operation.

10) A method according to claim 1, wherein the method includes, in the processing system, displaying a first representation indicative of the visual appearance of at least the first objects.

11) A method according to claim 1, wherein the method includes, in the processing system, updating the first representation using a selected at least one of:
a) a selection of at least one second object; and,
b) a selection of at least one second editing operation.

12) A method according to claim 1, wherein the method includes, in the processing system, determining, using user input commands, at least one of:
a) the first editing operations; and,
b) the selection of the at least one second object from the first objects.

13) A method according to claim 1, wherein the editing operations include at least one of:
a) moving an object;
b) resizing an object;
c) reshaping an object;
d) changing object colours;
e) adding an object;
f) removing an object; and,
g) editing text.

14) A method according to claim 1, wherein the method includes, in the processing system:
a) determining the first sequence of first operations from a global edit history; and,
b) using the at least one second operation to determine a local edit history.

15) A method according to claim 1, wherein the method includes, in the processing system:
a) displaying a first representation indicative of a visual appearance of objects in the document;
b) determine, using user input commands:
i) the first objects; and,
ii) the first editing operations;
c) applying the first editing operations to the first objects to determine a modified visual appearance for the first objects; and,
d) updating the first representation using the modified visual appearance.

16) A method according to claim 15, wherein the method includes, in the processing system:
a) determining selection of the at least one second object using user input commands;
b) determining the at least one second operation;
c) determining at least one change in visual appearance of the at least one second object; and,
d) generating the second representation using the at least one change in visual appearance.

17) A method according to claim 16, wherein the method includes, in the processing system:
a) determining a selected at least one second editing operation;
b) applying the selected second editing operation to at least one selected second object to determine a modified visual appearance for the at least one selected second object; and,
c) updating the first representation using the modified visual appearance.

18) A method according to claim 15, wherein the method includes, in the processing system, storing an indication of the visual appearance of the document.

19) Apparatus for reviewing editing operations applied in a document, the apparatus including a processing system for:
a) determining a first sequence of first editing operations applied to first objects in the document;
b) for at least one second object, the at least one second object being selected from the first objects, determining at least one second editing operation from the first sequence of first editing operations; and,
c) displaying a second representation indicative of the at least one second editing operation.

20) Apparatus according to claim 19, wherein the processing system includes a display for displaying at least one of:
a) the second representation; and,
b) a first representation indicative of at least the first objects.

21) Apparatus according to claim 19, wherein the processing system includes:
a) a memory for storing an indication of the first sequence of first operations; and,
b) a processor for:
i) retrieving the first sequence of first editing operations from the memory;
ii) determining the at least one second editing operation; and,
iii) generating the second representation.

22) Apparatus according to claim 19, wherein the processing system includes an input for receiving input commands from the user for determining at least one of:
a) the first editing operations; and,
b) the selection of the at least one second object from the first objects.

23) A computer program product for reviewing editing operations applied in a document, the computer program product including computer executable code which when executed on a suitable programmed processing system, causes the processing system to:
a) determine a first sequence of first editing operations applied to first objects in the document;
b) for at least one second object, the at least one second object being selected from the first objects, determine at least one second editing operation from the first sequence of first editing operations; and,
c) display a second representation indicative of the at least one second editing operation.
